(19) United States
(12) Patent Application Publication
(10) Pub. No.: US 2026/0037916 A1
(43) Pub. Date: Feb. 5, 2026

(54) Monitoring a store

(71) Applicant: Shopic Technologies LTD., Tel Aviv (IL)

(72) Inventors: Evyatar Nimrod Ben-Shtirit, Tel Aviv (IL); Shlomi Amitai, Tel Aviv (IL); Eran Goldman, Tel Aviv (IL); Eran Menahem Kravitz, Tel Aviv (IL); Raz Aharon Golan, Tel Aviv (IL)

(73) Assignee: Shopic Technologies LTD., Tel Aviv (IL)

(21) Appl. No.: 19/094,898

(22) Filed: Mar. 29, 2025

Related U.S. Application Data
(63) Continuation-in-part of application No. 18/793,704, filed on Aug. 2, 2024, now Pat. No. 12,333,740.
(60) Provisional application No. 63/717,139, filed on Nov. 6, 2024.

(51) Int. Cl. G06Q 10/087; G06V 10/62; G06V 10/80; G06V 20/52

(52) U.S. Cl. CPC G06Q 10/087; G06V 10/62; G06V 10/80; G06V 20/52

(57) ABSTRACT

There is provided a method for monitoring a store, the method includes (a) obtaining side images that are acquired, during one or more monitoring sessions, by one or more side cameras associated with one or more shopping containers that moves between one or more shelves located within a region of the store; and (b) determining, by a processor that comprises one or more integrated circuit, based on the side images, and using at least one machine learning process, shelved items information regarding an actual arrangement of items that are shelved during the one or more monitoring sessions, in the one or more shelves.

### CROSS REFERENCE

This application claims priority from U.S. patent application Ser. No. 18/793,704 filing date Aug. 2, 2024, which is incorporated herein by reference.

### BACKGROUND OF THE INVENTION

The content of the store dynamically changes. Sending dedicated employees to monitor the shelves multiple times a day is costly and ineffective. There is a growing need to monitor in a dynamic and accurate manner the items that are shelved in a store.

### SUMMARY

There are provided methods, non-transitory computer readable media and computerized systems as illustrated in the specification.

### BRIEF DESCRIPTION OF THE DRAWINGS

The subject matter that is regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawing in which:

FIG. 1 illustrates an example of a method;

FIG. 2 illustrates an example of a step of the method of FIG. 1;

FIG. 3 illustrates an example of a step of the method of FIG. 1;

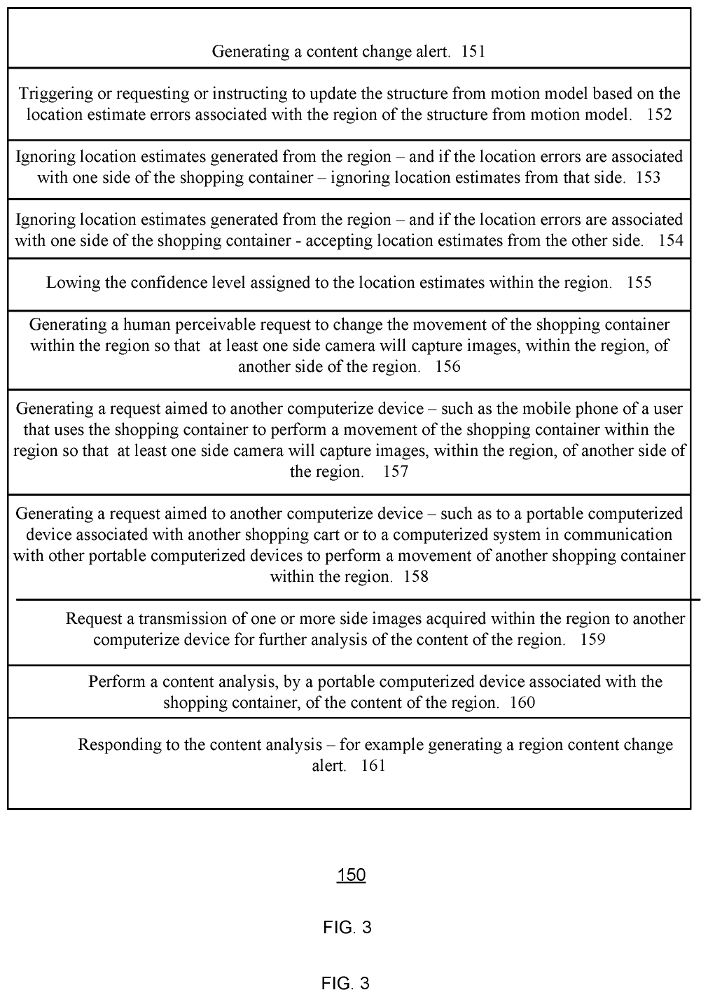

FIG. 4 illustrates an example of a structure from motion model;

FIG. 5 illustrates an example of a structure from motion model;

FIG. 6 illustrates an example of a portable computerized device;

FIG. 7 illustrates an example of a portable computerized device;

FIG. 8 illustrates an example of a portable computerized device

FIG. 9 illustrates examples of images;

FIG. 10 illustrates examples of shopping containers and fields of views of cameras;

FIG. 11 illustrates an example of a method;

FIG. 12 illustrates an example of a step of the method of FIG. 11;

FIG. 13 illustrates an example of a step of the method of FIG. 11;

FIG. 14 illustrates an example of a pair of side images; and

FIG. 15 illustrates an example of groups of products captured in a side image.

### DETAILED DESCRIPTION OF THE DRAWINGS

According to an embodiment, there is provided a method for monitoring a store.

According to an embodiment, the monitoring process provides shelved items information regarding an actual arrangement of items that are shelved during one or more monitoring sessions, in one or more shelves of a region of a store.

According to an embodiment the one or more monitoring sessions are one or more shopping sessions during which clients purchase products—and there may not be any need to perform dedicated monitoring sessions using trained personnel—which reduces the cost of the monitoring.

According to an embodiment, different regions of the store are “covered” over time—and the entire store or any part of the store may be covered during shopping sessions.

According to an embodiment, a region of the store is not pre-defined and is a region of the store that is visited by one or more clients during the one or more shopping sessions. A region may be of any shape and/or size and/or have an area that is any percentage of the overall area of the store.

According to an embodiment, more than a single region may be visited during a single shopping session.

According to an embodiment, when identifying that a given region of the store is not visited enough (for example at a rate that is below a defined rate threshold and/or during a period that exceeds a defined period threshold)—a request to visit that given region to provide coverage of the region may be triggered and/or may be implemented by a client and/or a dedicate staff member and/or by an autonomous shopping cart.

According to an embodiment, the acquisition of the side images and the generation of the shelved items information is executed repetitively over time and provides dynamic statuses of the shelved items—which enables to respond to the shelve items information (even in real-time) over prolonged periods of time.

According to an embodiment, the response may include comparing the actual arrangement of items (for example—a realogram) to a planned arrangement of items (for example—a planogram), to monitor trends related to the arrangement of the items within the store.

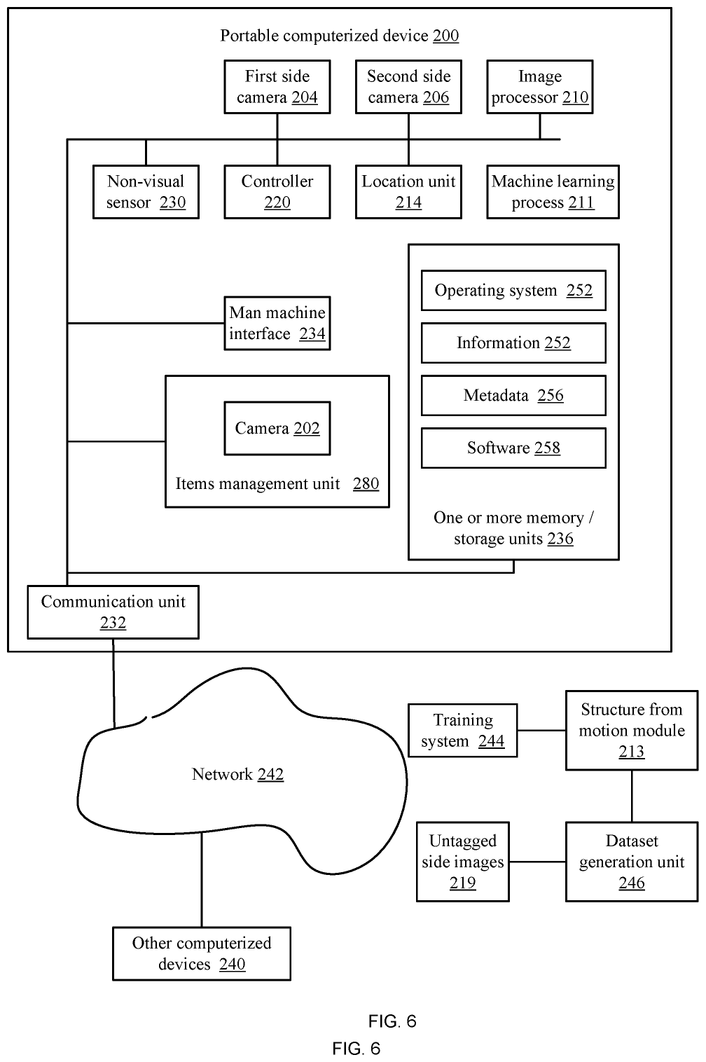

According to an embodiment, the determination of the shelved items information includes processing of side images that are acquired, during the one or more monitoring sessions, by one or more side cameras associated with one or more shopping containers that move within the store. Examples of side cameras and/or shopping containers and/or side images are illustrated in FIGS. 6-10 of the current application.

According to an embodiment, the processing of the side images includes ignoring one or more side images based on one or more parameters such as kinematic information regarding the speed of the side camera during the acquisition of the side images.

The speed may be determined based on image processing and/or shopping container speed sensors and/or shopping container acceleration sensors. The side cameras are carried by shopping containers.

According to an embodiment, a side image is ignored if the side image was acquired when the speed of the side camera exceeds a defined speed threshold.

According to an embodiment, the defined speed threshold is determined based on lighting conditions—and brighter illumination of a region increased the defined speed threshold.

According to an embodiment, the defined speed threshold is defined regardless of kinematic information associated with the side image acquisition.

According to an embodiment, the speed threshold is dependent on the expected content of the shelf—so that items that are easier to identify even when moving at higher speed—are associated with a higher speed threshold. Examples of items that are easier to identify include larger items, items that include classification anchors that are larger than classification anchors of other items, items that are expected to be more distant from each other, and the like.

According to an embodiment, the processing of the side images includes ignoring one or more side images based on one or more side image metric. According to an embodiment the side image metric is indicative of at least one of side image quality, side image focus condition, the presence of an occlusion, lighting conditions, and the like. The image metric may be calculated by the side camera and/or another processing circuit.

According to an embodiment, ignoring side images before performing other classification steps reduces the usage of processing and storage resources and increase the accuracy of the shelved items information is increase as images that may introduce classification errors are removed.

According to an embodiment, the processing of the side images includes (a) side image based processing of a plurality of side images in which the side images are processed on a side image basis, and (b) fusing information obtained from the side image based processing. This dual step process reduces the computational and memory resources consumption in comparison to the consumption associated with performing a single phase of processing without starting with side image based processing. Furthermore—the dual phase process reduces error propagation between different side images of at least partially overlapping side images.

According to an embodiment, the fusing is executed based, at least in part, on location metadata associated with the side images and indicative of locations of the side cameras when acquiring the side images.

According to an embodiment, the fusing is executed based, at least in part, on timing metadata indicative of a timing of acquisition of the side camera. The timing information allows to ignore side images that are tool old and are not relevant. The timing information may assist in fusing dies images acquired by the same side camera at timing proximity from each other.

According to an embodiment, the processing of the side images includes (a) identifying product groups by performing product group segmentation, and (b) identifying, within each product group the different items of the group—also using segmentation.

According to an embodiment, this dual phase process exhibits one or more of the following benefits:
a. Reduction of the computational and memory resources consumption in comparison to the consumption associated with a single segmentation process.
b. Simplification of the labeling.
c. Creates a generic algorithm that can be re-used on various regions of the store and across other stores—as the first phase of identifying product groups includes learning the concept of a product group, rather than learning each specific product group separately—which is easy to scale and/or to reduce the cost of segmentation.
d. The first phase extracts most of the relevant information to create a realogram.
e. It allows the developer to optimize the classification of a product group since the developer can create, from a single group of products, various sub-groups and classify each of them separately and then create a voting mechanism between the sub-results.
f. Even when facing with a new class of products and/or when there is a low confidence in a classification of a certain product, the first phase still defined a product group—even if the product itself is of an unknown class.

According to an embodiment the acquiring is executed by one or more side cameras of one or more shopping containers.

According to an embodiment the determination of the shelved items information is executed by one or more portable computerized devices (see, for example, portable computerized device 200 of FIG. 6) of shopping containers that also convey the one or more side cameras.

According to an embodiment the determination of the shelved items information includes processing the side images by one or more computerized devices (see for example other computerized devices 240 of FIG. 6) that are in communication with portable computerized devices (see, for example, portable computerized device 200 of FIG. 6) of shopping containers that also convey the one or more side cameras.

According to an embodiment, the determination of the shelved items information is partially executed by the one or more portable computerized devices (see, for example, portable computerized device 200 of FIG. 6) of shopping containers and is partially executed by the one or more computerized devices (see for example other computerized devices 240 of FIG. 6) that are in communication with portable computerized devices.

According to an embodiment, a portable computerized device of a shopping container determines which side image to ignore.

According to an embodiment, a portable computerized device of a shopping container performs a side image based processing of one or more side images acquired by one or more side cameras of the shopping container—and another computerized device performs the fusion of information.

According to an embodiment, a side image acquired by a side camera of a shopping container is processed by a portable computerized device of another shopping container.

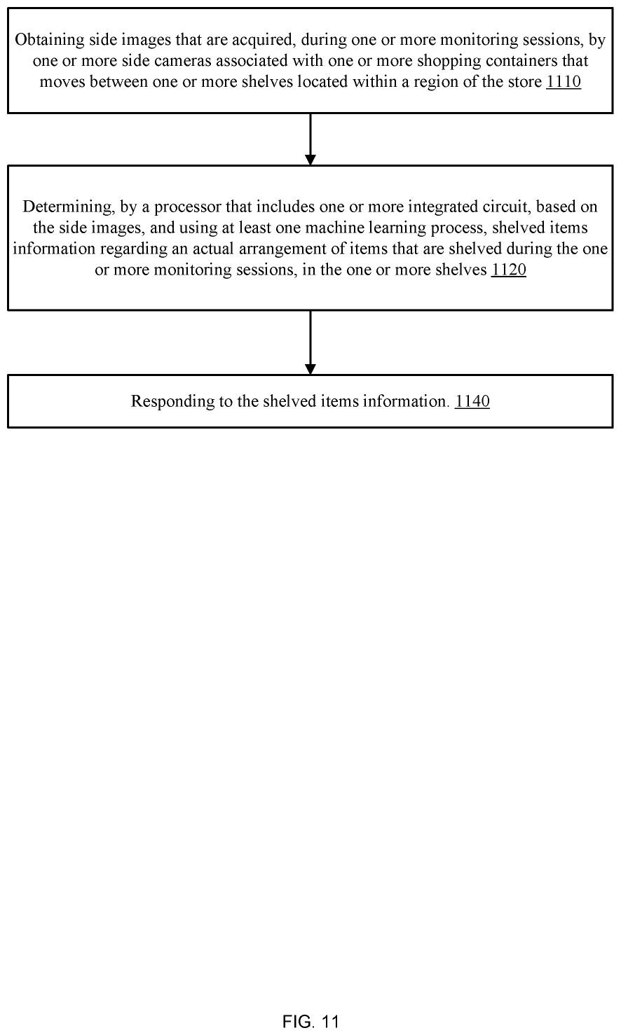

FIG. 11 illustrates an example of method 1100 for monitoring a store.

According to an embodiment, method 1100 includes step 1110 of obtaining side images that are acquired, during one or more monitoring sessions, by one or more side cameras associated with one or more shopping containers that moves between one or more shelves located within a region of the store.

According to an embodiment, step 1110 includes capturing the side images by one or more pairs of side cameras, each pair being associated with a shopping container and having fields of views that expand from different sides of the shopping container.

According to an embodiment, step 1110 is followed by step 1120 of determining, by a processor that includes one or more integrated circuit, based on the side images, and using at least one machine learning process, shelved items information regarding an actual arrangement of items that are shelved during the one or more monitoring sessions, in the one or more shelves.

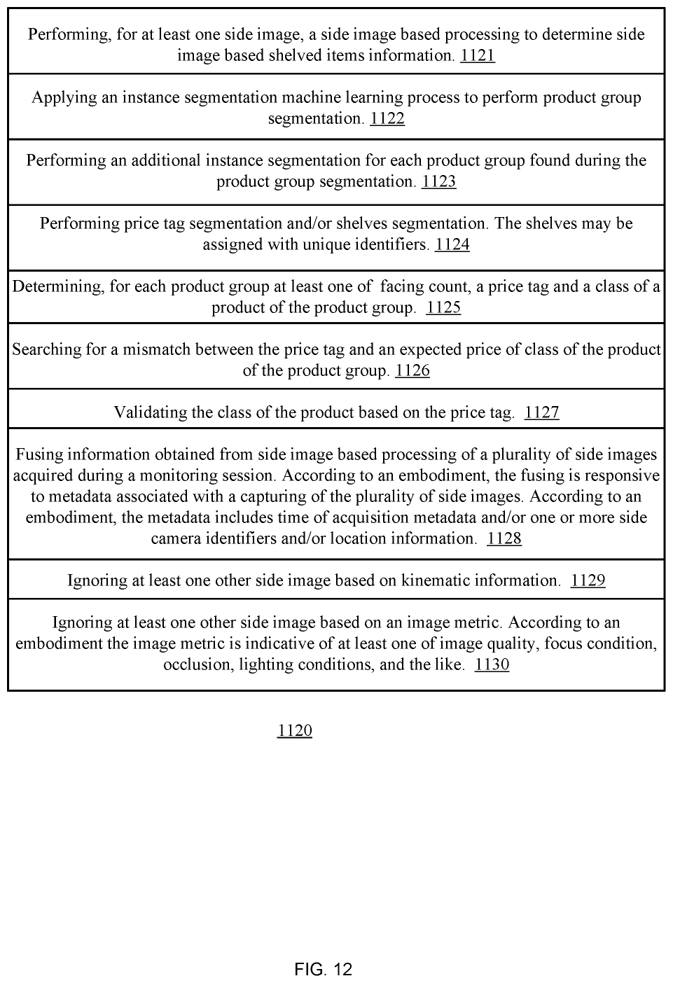

According to an embodiment, step 1120 includes (see FIG. 12) at least one of:
a. Step 1121 of performing, for at least one side image, a side image based processing to determine side image based shelved items information.
b. Step 1122 of applying an instance segmentation machine learning process to perform product group segmentation.
c. Step 1123 of performing an additional instance segmentation for each product group found during the product group segmentation.
d. Step 1124 of performing price tag segmentation and/or shelves segmentation. The shelves may be assigned with unique identifiers.
e. Step 1125 of determining, for each product group at least one of facing count, a price tag, and a class of a product of the product group.
f. Step 1126 of searching for a mismatch between the price tag and an expected price of class of the product of the product group.
g. Step 1127 of validating the class of the product based on the price tag.
h. Step 1128 of fusing information obtained from side image based processing of a plurality of side images acquired during a monitoring session. According to an embodiment, the fusing is responsive to metadata associated with a capturing of the plurality of side images. According to an embodiment, the metadata includes time of acquisition metadata and/or one or more side camera identifiers and/or location information.
i. Step 1129 of ignoring at least one other side image based on kinematic information.
j. Step 1130 of ignoring at least one other side image based on an image metric. According to an embodiment the image metric is indicative of at least one of image quality, focus condition, occlusion, lighting conditions, and the like.

According to an embodiment step 1122 and/or step 1123 include using a segmenting neural network such as a deep neural network—for example, a mask-RCNN or a Faster R-CNN. The mask-RCNN combines object detection and instance segmentation. It is an extension of the Faster R-CNN architecture. The Mask RCNN is configured to perform pixel-wise instance segmentation alongside object detection. This is achieved through the addition of an extra “mask head” branch, which generates segmentation masks for each detected object to provide pixel level resolution of segmented objects—being a group of items of items within a group of items.

According to an embodiment, the deep neural network is trained using supervised learning (or any other learning). The supervised learning may include using labeled data (ground trough data) and using a loss function that minimizes the distance between the ground truth and the output of the deep neural network—the distance may be determined in relation to the pixel masks (which defines the borders of the objects) and the segment label).

According to an embodiment, the one or more monitoring sessions are one or more shopping sessions.

According to an embodiment, step 1125 includes at least one of
a. Instance segmentation for each product to have a “facing count” (number of products that shopper sees (without depth).
b. Classification of the actual product using deep CNN.
c. Determine a relation between the group and one or more shelved on which the group of produces is placed.
d. Spatial relationships between different groups of products. The spatial relationship may be done on a shelf to shelf basis.
e. Performing price tag processing that includes extracting the price using optical character recognition (OCR).
f. Extracting a product name using OCR.
g. Extracting a product SKU using OCR or parsing barcode.
h. Extracting the product name and SKU using its visual appearance.
i. Finding a relationship between price tag and group of products.
j. Provide semantic information for each image, the semantic information includes at least some of:
   i. A side image timestamp
   ii. A portable computerized device identifier and/or a side camara identifier.
   iii. Side image related location information.
   iv. A number of shelves.
   v. For each shelf, an ordered data regarding the product groups.
   vi. For each product group:
      1. An SKU.
      2. A facing count.
      3. A price-tag.

According to an embodiment, step 1128 is performed per monitoring session and includes at least one of the following:
a. Match side images (or match information extracted from the side images processing) within the same monitoring session to have unified information. According to an embodiment, the matching can be done by:
   i. Semantic data matching (IoU/Jacrd Distance algo)
   ii. Location information if it is applicable. Location could be using any technique that provides location (radio beacons (WiFi, BT, BLE, UWB and etc.), It could be using SLAM techniques

According to an embodiment, step 1120 is followed by step 1140 of responding to the shelved items information.

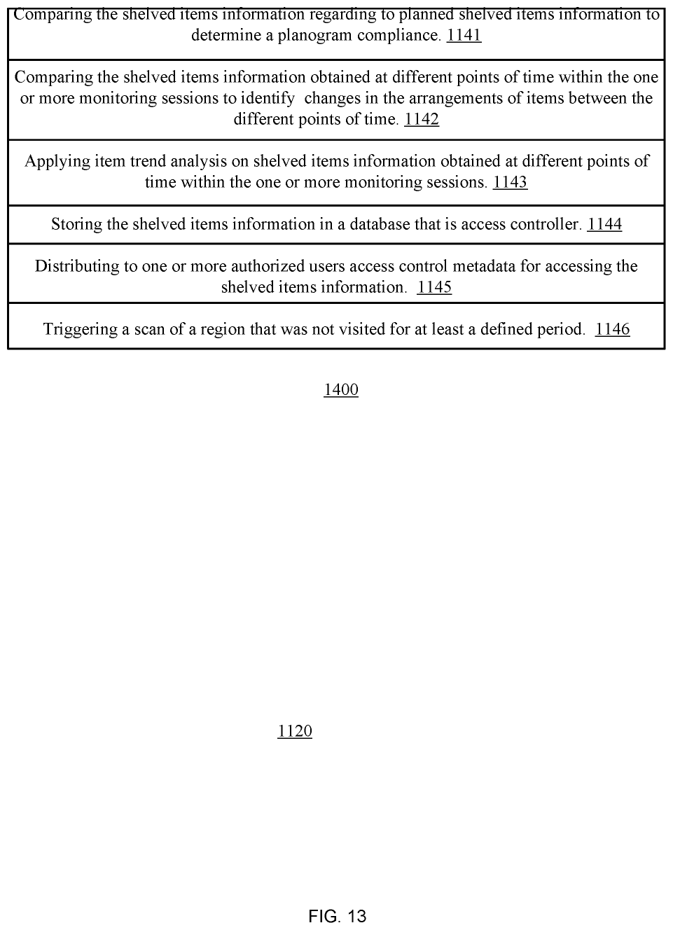

According to an embodiment, step 1140 includes (see FIG. 13) at least one of:
a. Step 1141 of comparing the shelved items information regarding to planned shelved items information to determine a planogram compliance.
b. Step 1142 of comparing the shelved items information obtained at different points of time within the one or more monitoring sessions to identify changes in the arrangements of items between the different points of time.
c. Step 1143 of applying item trend analysis on shelved items information obtained at different points of time within the one or more monitoring sessions.
d. Step 1144 of storing the shelved items information in a database that is access controller.
e. Step 1145 of distributing to one or more authorized users access control metadata for accessing the shelved items information.
f. Step 1146 of triggering a scan of a region that was not visited for at least a defined period.

According to an embodiment, step 1120 provides a partial realogram. based on a shopping session.

According to an embodiment, step 1140 includes at least one of:
a. Matching the partial realogram to the store planogram to locate the partial realogram components in the store.
b. Transferring the partial realogram to a computerized system such as central computerized system.
c. Applying, by the central computerized system, one or more matching algorithms between different partial realograms—using any of the algorithms mentioned above-or using one or more other algorithms.

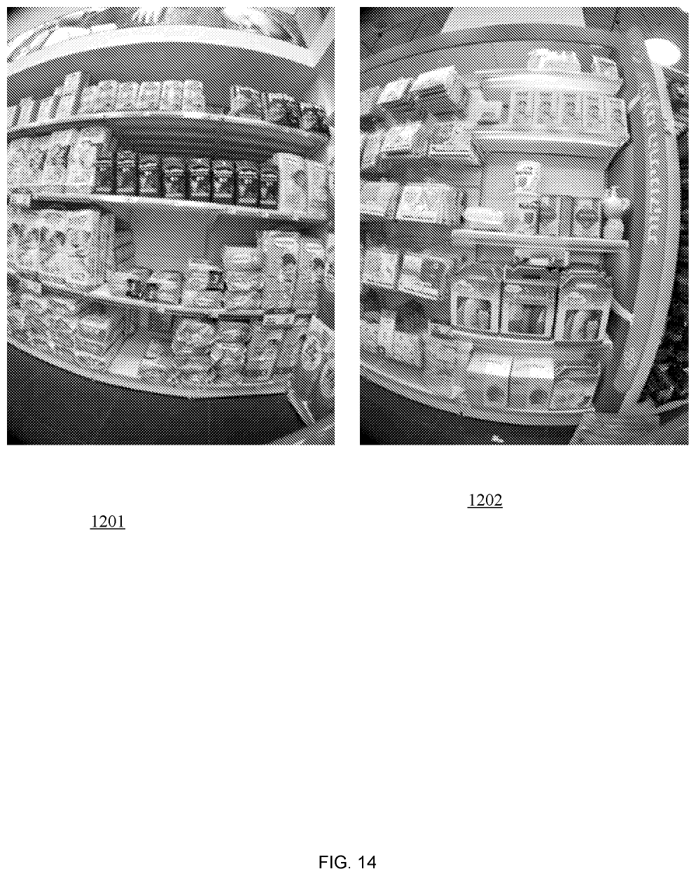

FIG. 14 illustrates an example of a pair of side images 1201 and 1202.

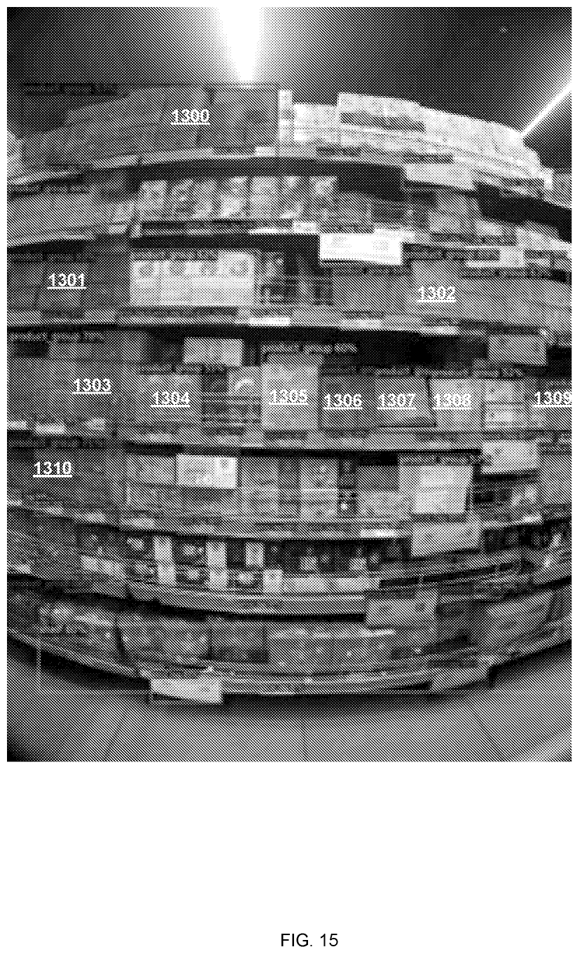

FIG. 15 illustrates an example of groups of products 1300-1310 captured by side image 1203.

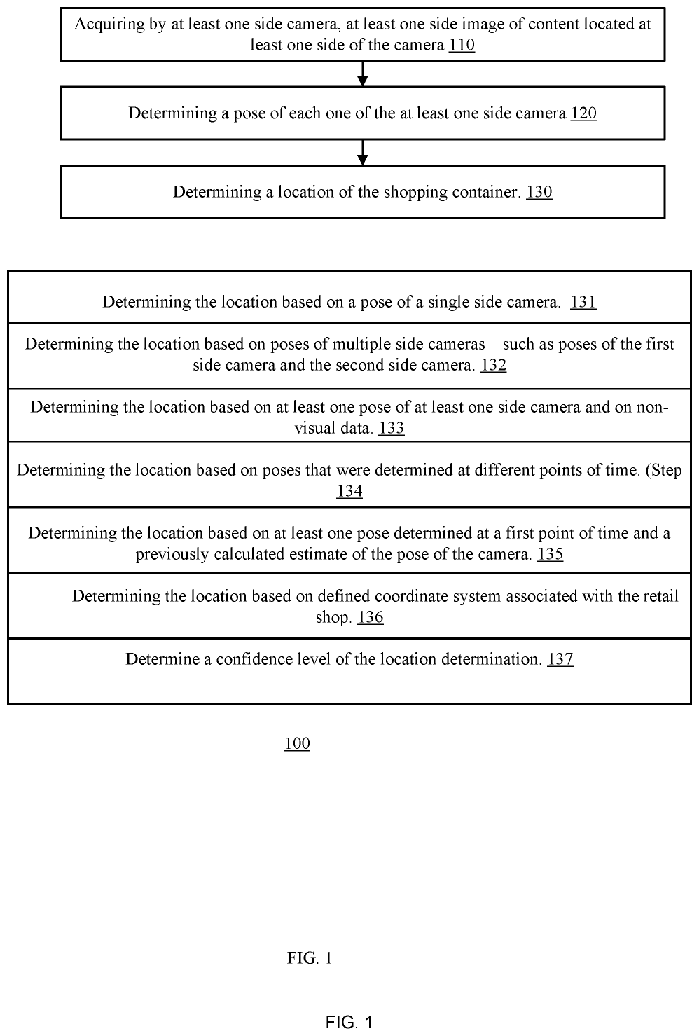

FIG. 1 illustrates an example of method 100 for locating a shopping container.

According to an embodiment, method 100 includes steps 110, 120 and 140.

Step 110 includes acquiring, by at least one side camera, at least one side image of content located at least one side of the camera.

Shops includes lanes formed between shelves and users usually move along the lanes. Using a side images is more beneficial for location determination than front cameras—especially when not having dedicated distance location elements such as LIDARs.

According to an embodiment, the at least one side camera is a first side camera associated with the shopping container, and configured to acquire a first side image of first content located to a first side of the shopping container. Acquiring a side first side image of first content located to a first side of the shopping container by a first side camera is to determine the location of the shopping container within the store. This is for the real-time and high accuracy location of shopping containers within an indoor store environment.

The first side camera captures the side first side image to facilitate the determination of the shopping container's location.

The shopping container, which can be a shopping cart, is equipped with this first side camera to enable this process. The first side camera's acquisition of the side first side image is for the subsequent steps in the method. The captured image provides the data for determining the pose of the first side camera.

A pose of a camera represents the location and the orientation of the camera.

This pose determination is based on the first side image and is performed by a machine learning process trained using a structure from motion model of the store.

The structure from motion model is generated from untagged side images acquired by side cameras of shopping containers that moved within the store during an image acquisition process.

Using the untagged side images greatly simplifies and reduces the cost of the generation of a dataset used to training the machine learning process. The acquisition of the untagged images does not require using trained personnel—rather asking a layperson to move within the store—which also greatly simplifies the process and reduces the cost associated with the process.

These untagged side images are associated with side cameras pose information learned during the generation of the structure from motion model.

The structure from motion model is generated from untagged side images acquired by side cameras of shopping containers that moved within the store during an image acquisition process. The structure from motion model is used to train the machine learning process for determining the pose of the cameras and ultimately the shopping container's location.

The machine learning process, which is trained using this structure from motion model, plays a role in determining the pose of the first side camera. Determining the pose of the first side camera based on the first side image and by a machine learning process trained using a structure from motion model of the store is to facilitate the determination of the shopping container's location. This process ensures that the location determination is accurate and reliable, leveraging the data from the first side image and the trained machine learning model. The goal of these actions is to determine the location of the shopping container based on the pose of the first camera. This allows for the precise location of the shopping container within the store. Determining the location of the shopping container is to enable the real-time and high accuracy location of shopping containers within an indoor store environment.

This method does not require extra hardware such as location transmitting beacons or other locating assisting hardware elements that have to be installed within the indoor store and require maintenance. The solution is designed to be efficient in human resources and time consumption, easy to scale, and able to adapt to ongoing changes in the store. It also does not require time-consuming supervised training in a machine learning process, making it practical for real-world applications.

According to an embodiment, the at least one side camera includes the first side camera and a second side camera that is adapted to acquire a second side image of second content located to a second side of the shopping container.

The second side differs from the first side. The second side may be opposite to the first side or may be oriented by any angle. It has been found that the using multiple side cameras is more beneficial when the fields of view of the first side camera and the second side camera do not overlap. Partial overlap may be more beneficial than a full overlap.

Acquiring a side second side image of second content located to a second side of the shopping container by a second side camera is also used to determine the location of the shopping container within the store. This is for the real-time and high accuracy location of shopping containers within an indoor store environment.

The second side camera captures the side second side image to facilitate the determination of the shopping container's location.

According to an embodiment, using location estimates from more than a single side camera increases the location determination accuracy.

In step 120, the process involves determining a pose of each one of the at least one side camera.

According to an embodiment, the pose of the first side camera is determined based on the first side image and by a machine learning process trained using a structure from motion model of the store.

According to an embodiment, the pose of the first side camera is determined based on the first side image and by the machine learning process trained using a structure from motion model of the store. In addition, the pose of the second side camera is determined based on the second side image and by the machine learning process trained using a structure from motion model of the store.

In summary, step 120 involves a detailed and multi-faceted approach to determining the pose of the at least one side camera using the machine learning process trained with the structure from motion model.

According to an embodiment, step 120 is followed by step 130 of determining a location of the shopping container. Any other response to the outcome of step 120 may be provided.

According to an embodiment, step 130 includes determining a location of the shopping container.

According to an embodiment, step 130 includes at least one of:
a. Determining the location based on a pose of a single side camera. (Step 131).
b. Determining the location based on poses of multiple side cameras—such as poses of the first side camera and the second side camera. (Step 132).
c. Determining the location based on at least one pose of at least one side camera and on non-visual data. (Step 133).
d. Determining the location based on poses that were determined at different points of time. (Step 134).
e. Determining the location based on at least one pose determined at a first point of time and a previously calculated estimate of the pose of the camera. (Step 135).
f. Determining the location based on defined coordinate system associated with the retail shop. (Step 136).
g. Determine a confidence level of the location determination. (Step 137).

According to an embodiment, step 130 is followed by step 140 of responding to the location estimate.

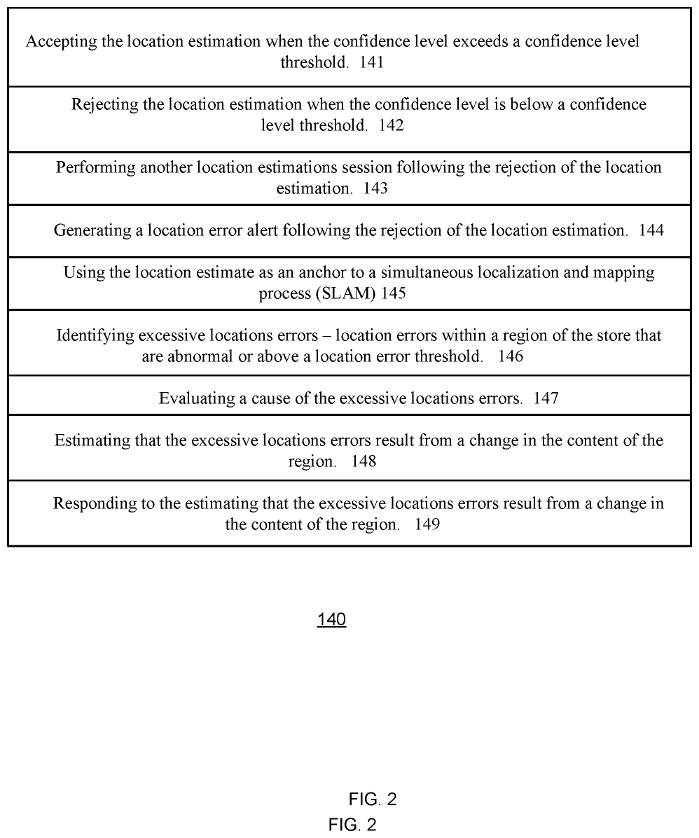

According to an embodiment, step 140 includes at least one of the following steps—as illustrated in FIG. 2:
a. Accepting the location estimation when the confidence level exceeds a confidence level threshold. (Step 141).
b. Rejecting the location estimation when the confidence level is below a confidence level threshold. (Step 142).
c. Performing another location estimations session following the rejection of the location estimation. (Step 143).
d. Generating a location error alert following the rejection of the location estimation. (Step 144).
e. Using the location estimate as an anchor to a simultaneous localization and mapping process (SLAM). (Step 145).
f. Identifying excessive locations errors—location errors within a region of the store that are abnormal or above a location error threshold. (Step 146).
g. Evaluating a cause of the excessive locations errors. (Step 147).
h. Estimating that the excessive locations errors result from a change in the content of the region. (Step 148).
i. Responding to the estimating that the excessive locations errors result from a change in the content of the region. (Step 149).

According to an embodiment, step 150 of responding to the estimating that the excessive locations errors may include at least one of the following steps—as illustrated in FIG. 2:
i. Generating a content change alert. (Step 151).
ii. Triggering, requesting, or instructing to update the structure from motion model based on the location estimate errors associated with the region of the structure from motion model. (Step 152).
iii. Ignoring location estimates generated from the region—and if the location errors are associated with one side of the shopping container—ignoring location estimates from that side. (Step 153).
iv. Ignoring location estimates generated from the region—and if the location errors are associated with one side of the shopping container—accepting location estimates from the other side. (Step 154).
v. Lowing the confidence level assigned to the location estimates within the region. (Step 155).
vi. Generating a human perceivable request to change the movement of the shopping container within the region so that at least one side camera will capture images, within the region, of another side of the region. For example—moving the shopping container in the opposite direction. (Step 156).

vii. Generating a request aimed to another computerize device—such as the mobile phone of a user that uses the shopping container to perform a movement of the shopping container within the region so that at least one side camera will capture images, within the region, of another side of the region. For example—moving in the opposite direction. (Step 157).
viii. Generating a request aimed to another computerize device—such as to a portable computerized device associated with another shopping cart or to a computerized system in communication with other portable computerized devices to perform a movement of another shopping container within the region. (Step 158).
ix. Request a transmission of one or more side images acquired within the region to another computerize device for further analysis of the content of the region. (Step 159).
x. Perform a content analysis, by a portable computerized device associated with the shopping container, of the content of the region. (Step 160).
xi. Responding to the content analysis—for example generating a region content change alert. (Step 161).

The triggering of an update of the structure from motion model is to maintain or improve the accuracy of the model. This is done based on location estimate errors associated with a region of the structure from motion model.

Triggering an update of the structure from motion model based on location estimate errors refines and improves the model even when the region is changed. This ensures that the location process can adapt to on-going changes in the store, making it easy to scale.

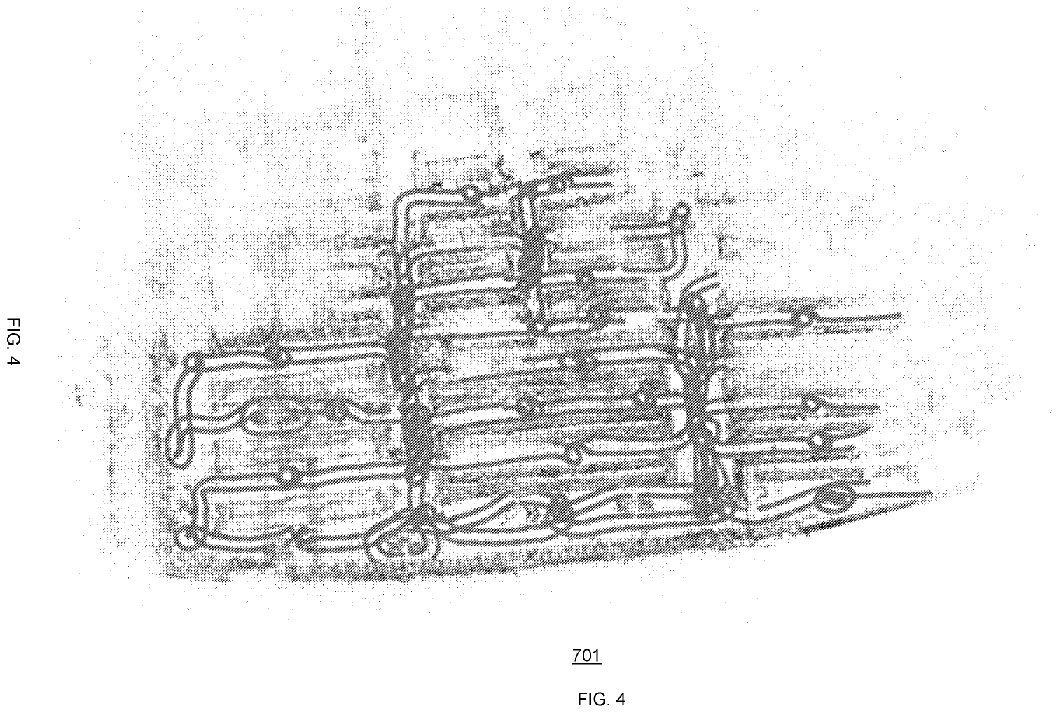

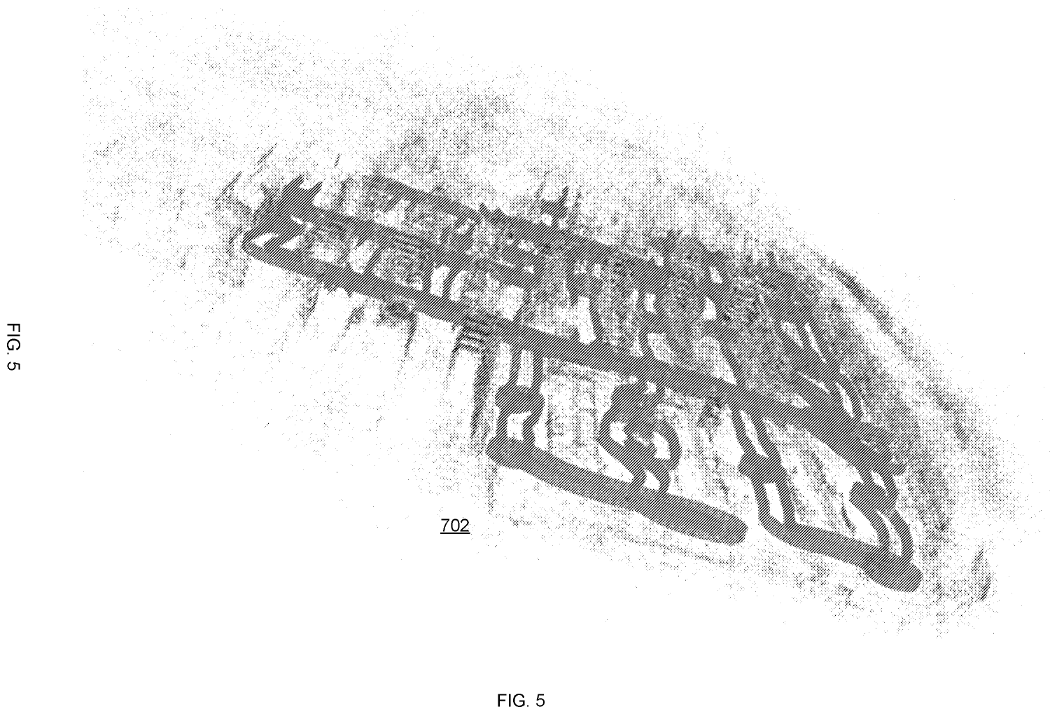

In an example:
a. The structure from motion model was COLMAP, introduced in “Structure-from-Motion Revisited” by Johannes L. Schonberger and Jan-Michael Frahm, which is incorporated herein by reference. FIGS. 4 and 5 illustrate examples of portions 701, 702 and 703 of a COLMAP in which the shelves are illustrated by dots and the pathways within the store are illustrated by lines.
b. The pose was represented by a cartesian location coordinates (for example, X, Y and Z) and quaternion orientation coordinates (QW, QX, QY, QZ)—although other coordinate systems may be used. In an example, the quaternion is defined using the Hamilton convention, which is, for example, also used by the Eigen library.
c. The coordinates of the projection/camera center are given by—R\hat{ }t*T, where R\hat{ }t is the inverse/transpose of the 3×3 rotation matrix composed from the quaternion and T is the translation vector. The local camera coordinate system of an image is defined in a way that the X axis points to the right, the Y axis to the bottom, and the Z axis to the front as seen from the image.
d. The determination of the location of the portable computerized device included determining the world coordinates of the image coordinates. This included:
   i. Defining a coordinate system to the store.
   ii. For all images using a quaternion (QW, QX, QY, QZ) and a translation vector of the sparse 3D reconstructed model, calculate the Rotation, Translation and Scale parameters in camera coordinate system (image projection to camera).
   iii. For all images use the calculated parameters (rotation, translation, and scale) together with camera intrinsic parameters to compute the world coordinates of each image of the sparse 3D reconstructed model.
   iv. Using a few images of the model finding the calculated world location, find their location in the desired store coordinate system.
   v. Find the transformation (rotation, translation, and scale) between the calculated world coordinate system and the store coordinate system.
   vi. Use a word to store translation, rotation and scale and convert all images to store coordinate system.
e. The machine learning process is implemented using a deep neural network designed for absolute pose regression. The deep neural network has a backbone of GoogLeNet, one or more heads of regression and using a loss function responsive to a location mean square error and to an orientation mean square loss.

It should be noted that other neural networks may be used, that other loss function can be applied, and the like.

FIG. 6 is a block diagram of a portable computerized device 200 configured for tracking items in a shopping container, its environment, as well as training system, 244 for training the machine learning process, dataset generation unit 246 configured to generate the structure from motion module 213 from at least untagged side images 219.

According to an embodiment, the portable computerized device 200 includes:
a. A camera 202 configured to capture one or more images of an item being inserted to or removed from the shopping container.
b. A first side camera 204 configured to acquire a side first side image of first content located to a first side of the shopping container.
c. An image processor 210 configured to determine a pose of the first side camera, based on the first side image and by a machine learning process trained using a structure from motion model of the store, wherein the structure from motion model is generated from untagged side images acquired by side cameras of shopping containers that moved within the store during an image acquisition process, wherein the untagged side images are associated with side cameras pose information learnt during the generation of the structure from motion model. According to an embodiment the image processor is a dedicated machine learning processor—or includes machine learning processing capabilities and one or more other capabilities. The machine learning process is denoted 211.
d. A location unit 214 configured to determine the location of the shopping container based on the pose of the first camera.
e. A controller 220 for controlling components of the shopping container.
f. A non-visual sensor 230 configured to provide non-visual information regarding the location of the shopping container.
g. Communication unit 232 configured to communicate with other computerized devices 240 over network 242. The other computerized devices may be one or more mobile devices of one or more users, one or more other portable computerized devices associated with one or more shipping containers, a computerized system (such as central computerized system) in communication with other portable computerized devices.
h. Man machine interface 234 configured to communicate with a user of the shopping container.
i. One or more memory/storage units 236.

According to an embodiment, the portable computerized device include fewer or more components than those illustrated in (a)-(i)—for example, the portable computerized device may not include the non-visual sensor and/or the other camera and/or the second side camera, and the like.

According to an embodiment, the portable computerized device 300 includes items management unit 280 configured to monitor the insertion of items into the shopping container, monitor the removal of items from the shopping container and perform any other operation related to the payment for items. Some of the components of the items management unit 230 are included in the portable computerized device illustrated in US patent application 2023/048635 titled “System and method for fast checkout using a detachable computerized device” which is incorporated herein by reference. Some of these components are illustrated in FIG. 2 of US patent application 2023/048635 and include an object detection module, a classification module, a machine learning chip, a shopping management module, a scanner, cameras, and the like. According to an embodiment, at least some of the components are also usable for implementing other tasks—for example assisting in the determining of the location of the shopping container.

According to an embodiment, the items management unit 280 includes camera 202 (or one or more cameras) for tracking items being inserted or removed from the shopping container.

The image processor and the location unit may be different hardware components, may be different software components, or may share at least one software or hardware resource. The image processor and the location unit may include one or more processing circuits. A processing circuit includes one or more integrated circuits or may belong to an integrated circuit. A processing circuit may be a general purpose processing circuit, a specialized processing circuit such as a machine learning integrated circuit, a graphic unit processor, and the like.

According to an embodiment, the portable computerized device also includes one or more additional side cameras such as second side camera 206 that is configured to acquire a second side image of second content located to a second side of the portable computerized device.

The second side differs from the first side. The second side may be opposite to the first side or may be oriented by any angle. It has been found that the using multiple side cameras is more beneficial when the fields of view of the first side camera and the second side camera do not overlap. Partial overlap may be more beneficial than a full overlap.

According to an embodiment, the image processor 210 is configured to determine the pose of the second camera, based on the second side image and by the machine learning process.

According to an embodiment, the location unit 214 is configured to determine the location of the portable computerized device also based on the pose of the second camera.

According to an embodiment, using location estimates from more than a single side camera increases the location determination accuracy.

This pose determination is based on one or more side images and is performed by a machine learning process trained using a structure from motion model of the store.

The structure from motion model is generated from untagged side images acquired by side cameras of shopping containers that moved within the store during an image acquisition process.

These untagged side images are associated with side cameras pose information learned during the generation of the structure from motion model.

The structure from motion model is generated from untagged side images acquired by side cameras of shopping containers that moved within the store during an image acquisition process. The structure from motion model is used to train the machine learning process for determining the pose of the cameras and ultimately the shopping container's location.

The machine learning process, which is trained using this structure from motion model, plays a role in determining the pose of the first side camera. Determining the pose of the first side camera based on the first side image and by a machine learning process trained using a structure from motion model of the store is to facilitate the determination of the shopping container's location. This process ensures that the location determination is accurate and reliable, leveraging the data from the first side image and the trained machine learning model. The goal of these actions is to determine the location of the shopping container based on the pose of the first camera. This allows for the precise location of the shopping container within the store. Determining the location of the shopping container is to enable the real-time and high accuracy location of shopping containers within an indoor store environment.

This portable computerized system is configured to determine the location of the shopping container without requiring extra hardware such as location transmitting beacons or other locating assisting hardware elements that have to be installed within the indoor store and require maintenance. The solution is designed to be efficient in human resources and time consumption, easy to scale, and able to adapt to ongoing changes in the store. It also does not require time-consuming supervised training of a machine learning process, making it practical for real-world applications.

According to an embodiment, the machine learning process was trained using a loss function applied on location estimates provided based on first side images and on location estimated based on second side images.

According to an embodiment, the machine learning process was trained using a loss function applied on location estimates provided based on first side images and not on second side images—and vice versa.

According to an embodiment, the portable computerized device the location 214 is configured to perform at least one step of the following steps:
a. Determining the location based on a pose of a single side camera.
b. Determining the location based on poses of multiple side cameras—such as poses of the first side camera and the second side camera.
c. Determining the location based on at least one pose of at least one side camera and on non-visual data.
d. Determining the location based on poses that were determined at different points of time.
e. Determining the location based on at least one pose determined at a first point of time and a previously calculated estimate of the pose of the camera.
f. Determining the location based on defined coordinate system associated with the retail shop.
g. Determine a confidence level of the location determination.

According to an embodiment, the portable computerized system is also configured to respond to the location estimate by performing at least one of the following steps:
a. Accepting the location estimation when the confidence level exceeds a confidence level threshold.
b. Rejecting the location estimation when the confidence level is below a confidence level threshold.
c. Performing another location estimations session following the rejection of the location estimation.
d. Generating a location error alert following the rejection of the location estimation.
e. Using the location estimate as an anchor to a simultaneous localization and mapping process (SLAM).
f. Identifying excessive locations errors-location errors within a region of the store that are abnormal or above a location error threshold.
g. Evaluating a cause of the excessive locations errors.
h. Estimating that the excessive locations errors result from a change in the content of the region.
i. Responding to the estimating that the excessive locations errors result from a change in the content of the region.

According to an embodiment, portable computerized system is also configured to respond to the estimating that the excessive locations errors by performing at least one of the following steps:
i. Generating a content change alert.
ii. Triggering, requesting, or instructing to update the structure from motion model based on the location estimate errors associated with the region of the structure from motion model.
iii. Ignoring location estimates generated from the region—and if the location errors are associated with one side of the shopping container—ignoring location estimates from that side.
iv. Ignoring location estimates generated from the region—and if the location errors are associated with one side of the shopping container-accepting location estimates from the other side.
v. Lowing the confidence level assigned to the location estimates within the region.
vi. Generating a human perceivable request to change the movement of the shopping container within the region so that at least one side camera will capture images, within the region, of another side of the region. For example—moving the shopping container in the opposite direction.
vii. Generating a request aimed to another computerize device—such as the mobile phone of a user that movers the shopping container to perform a movement of the shopping container within the region so that at least one side camera will capture images, within the region, of another side of the region. For example—moving in the opposite direction.
viii. Generating a request aimed to another computerize device—such as to a portable computerized device associated with another shopping cart or to a computerized system in communication with other portable computerized device to perform a movement of another shopping container within the region.
ix. Request a transmission of one or more side images acquired within the region to another computerize device for further analysis of the content of the region.
x. Perform a content analysis, by a portable computerized device associated with the shopping container, of the content of the region.
xi. Responding to the content analysis—for example generating a region content change alert.

According to an embodiment, the responding may involve using at least one of the image processor 210, location unit 214, controller 220, communication unit 232, Man machine interface 234, or one or more memory/storage units 236.

According to an embodiment, the one or more memory and/or storage units 236 includes one or more memory unit, each memory unit may include one or more memory banks.

According to an embodiment, the one or more memory and/or storage units 236 includes a volatile memory and/or a non-volatile memory. The one or more memory and/or storage units 236 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database-such as any database known in the art—such as DB2®, Microsoft® Access, Microsoft® SQL Server, Oracle®, mySQL, PostgreSQL, and the like.

The memory and/or storage units 236 are configured to store firmware and/or software, one or more operating systems, data and metadata required to the execution of any of the methods mentioned in this application.

The memory and/or storage units 236 was shown as storing software. Any reference to software should be applied mutatis mutandis to code and/or firmware and/or instructions and/or commands, and the like.

Various units and/or components are in communication with each other using any communication elements and/or protocols.

The communication system 232 may be in communication with a bus. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 242 is located outside the vehicle and is used for communication between the portable computerized device and other computerized systems. Logical connections between the processor and remote computing systems can be made via a local area network (LAN) and a general wide area network (WAN). Such network connections can be through a network adapter (may belong to communication system 630) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 236 may be stored outside the vehicle. It should also be noted that the processor may evaluate signatures generated by a plurality of detectors.

According to an embodiment, the memory and/or storage units 236 stores at least one of: operating system 252, information 254, metadata 256, and software 258- all being used by the portable processing device for executing any method illustrated in this application.

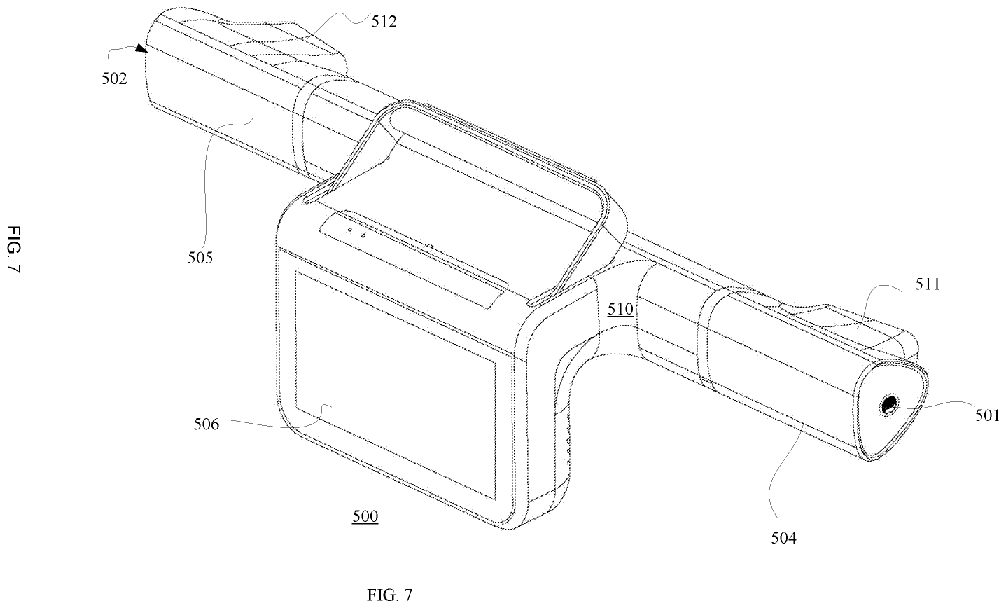

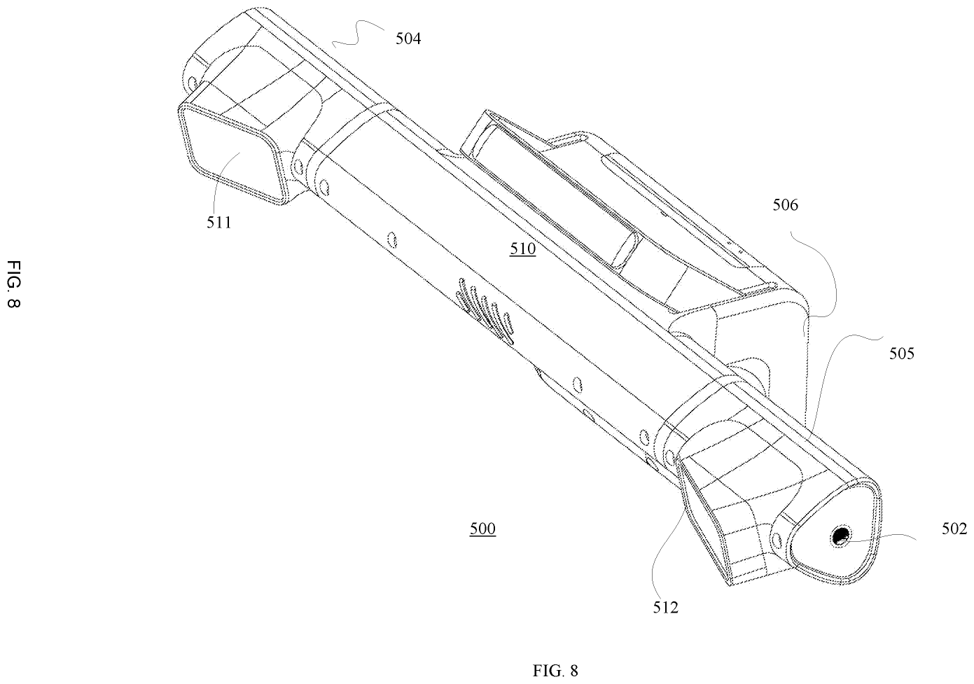

FIGS. 7 and 8 illustrate examples of a portable computerized device 500 including a body 510, a first side camera 501 and a second side camera 502 included within handles 504 and 505, display 506, and two cameras 511 and 512 configured to capture one or more images of an item being inserted to or removed from the shopping container.

The portable computerized device 500 may be detachably connected to the shopping container—in various manners—for example as illustrated in US patent application 2023/048635 titled “System and method for fast checkout using a detachable computerized device” which is incorporated herein by reference.

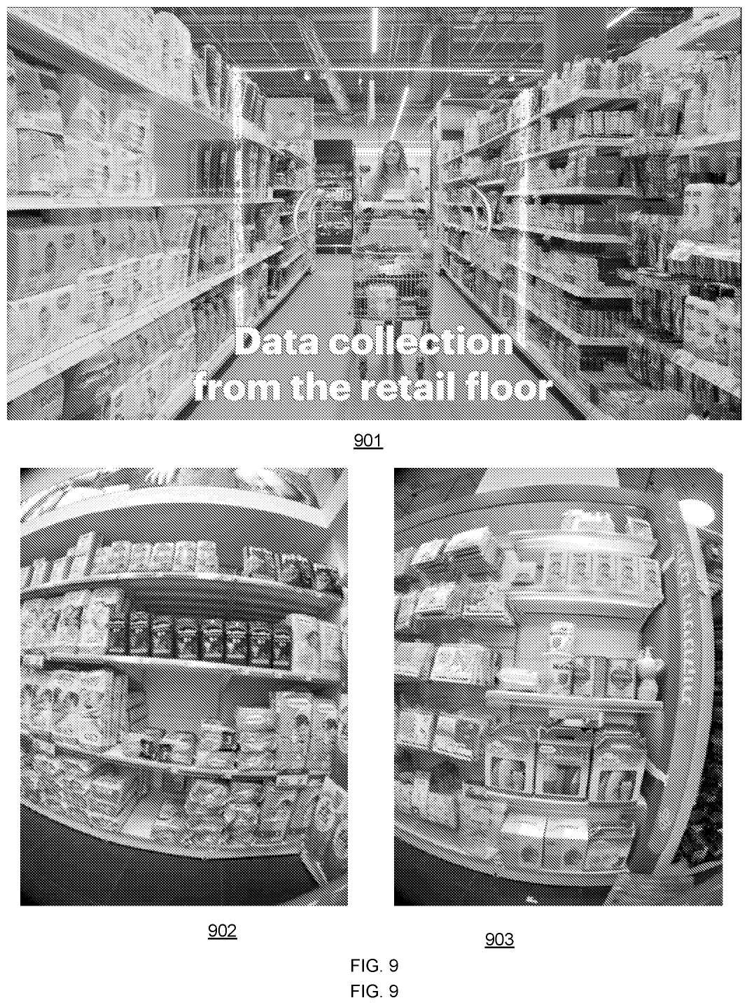

FIG. 9 illustrates an example of an image 901 of shopping container 400, shelves and fields of view of the first side camera and of the second side camera. FIG. 9 also illustrates an example of a first side image 902 and a second side image 903.

According to an embodiment the side cameras have a fish-eye lens.

According to an embodiment the side camera includes a field of view that has a height that exceeds its height.

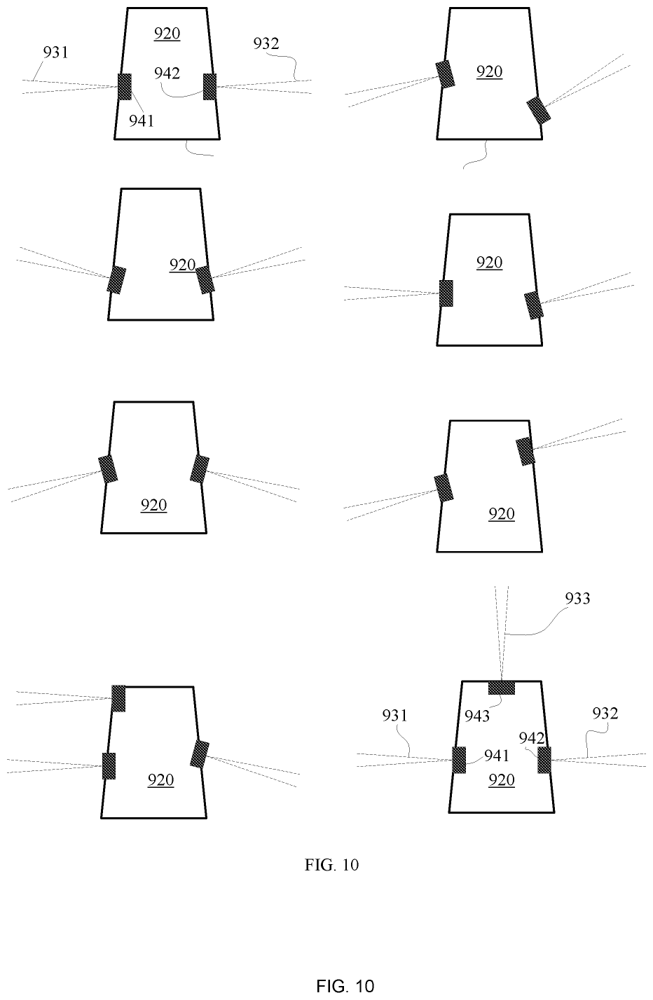

FIG. 10 illustrates examples of shopping containers 920 and fields of views 931, 932 and 933 of side cameras 941, 942 and 943.

It should be noted that the shopping container may be associated with any number of cameras and may be associated with one or more front cameras.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using microelectronics and/or optical components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a system or device should be applied mutatis mutandis to a method that may be executed by the system, and/or may be applied mutatis mutandis to non-transitory computer readable medium that stores instructions executable by the system.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for monitoring a store, the method comprises:
obtaining side images that are acquired, during one or more monitoring sessions, by one or more side cameras associated with one or more shopping containers that moves between one or more shelves located within a region of the store; and
determining, by a processor that comprises one or more integrated circuit, based on the side images, and using at least one machine learning process, shelved items information regarding an actual arrangement of items that are shelved during the one or more monitoring sessions, in the one or more shelves.

2. The method according to claim 1, wherein the obtaining of the side images comprises capturing the side images by one or more pairs of side cameras, each pair being associated with a shopping container and having fields of views that expand from different sides of the shopping container.

3. The method according to claim 1, wherein the determining comprises performing, for at least one side image, a side image based processing to determine side image based shelved items information.

4. The method according to claim 3, wherein the side image based processing comprises applying an instance segmentation machine learning process to perform product group segmentation.

5. The method according to claim 4, further comprising performing an additional instance segmentation for each product group found during the product group segmentation.

6. The method according to claim 4, further comprising price tag segmentation and shelves segmentation.

7. The method according to claim 4, further comprising determining, for each product group a facing count, a price tag, and a class of a product of the product group. (ID by SKU)

8. The method according to claim 7, further comprising searching for a mismatch between the price tag and an expected price of class of the product of the product group.

9. The method according to claim 7, further comprising validating the class of the product based on the price tag.

10. The method according to claim 3, further comprising fusing information obtained from side image based processing of a plurality of side images acquired during a monitoring session.

11. The method according to claim 10, wherein the fusing is responsive to metadata associated with a capturing of the plurality of side images.

12. The method according to claim 11, wherein the metadata comprises time of acquisition metadata and one or more side camera identifiers.

13. The method according to claim 3, wherein the determining comprises ignoring at least one other side image based on kinematic information.

14. The method according to claim 3, wherein the determining comprises ignoring at least one other side image based on an image metric (bad focus, occlusion, low quality, not enough light)

15. The method according to claim 1, wherein the one or more monitoring sessions are one or more shopping sessions.

16. The method according to claim 1, comprising comparing the shelved items information regarding to planned shelved items information to determine a planogram compliance.

17. The method according to claim 1, comprising comparing the shelved items information obtained at different points of time within the one or more monitoring sessions to identify changes in the arrangements of items between the different points of time.

18. The method according to claim 1, comprising applying item trend analysis on shelved items information obtained at different points of time within the one or more monitoring sessions.

19. The method according to claim 1, wherein the determining of the shelved items information is responsive to location information associated with the side images.

20. The method according to claim 1, wherein the obtaining of the side images comprises acquiring the side images, during one or more monitoring sessions, by the one or more side cameras.

21. The method according to claim 1, further comprising storing the shelved items information in a database that is access controller and distributing to one or more authorized users access control metadata for accessing the shelved items information.

22. A non-transitory computer readable medium for monitoring a store, the non-transitory computer readable medium stored instructions executable by a processor for:
obtaining side images that are acquired, during one or more monitoring sessions, by one or more side cameras associated with one or more shopping containers that moves between one or more shelves located within a region of the store; and
determining, by a processor that comprises one or more integrated circuit, based on the side images, and using at least one machine learning process, shelved items information regarding an actual arrangement of items that are shelved during the one or more monitoring sessions, in the one or more shelves.

23. A computerized system for monitoring a store, comprising:
a memory unit configured to store side images that are acquired, during one or more monitoring sessions, by one or more side cameras associated with one or more shopping containers that moves between one or more shelves located within a region of the store; and
a processor that comprises one or more integrated circuits and is configured to determine, based on the side images, and using at least one machine learning process, shelved items information regarding an actual arrangement of items that are shelved during the one or more monitoring sessions, in the one or more shelves.
